(19) United States
(12) Patent Application Publication
(10) Pub. No.: US 2010/0040776 A1
(43) Pub. Date: Feb. 18, 2010

(54) Laminate Countertop Coating Kit in a Do-it-Yourself Format

(76) Inventor: Richard R. Keigley, Sedona, AZ (US)

Correspondence Address: BERENATO & WHITE, LLC, 6550 ROCK SPRING DRIVE, SUITE 240, BETHESDA, MD, 20817, US

(21) Appl. No.: 12/416,367

(22) Filed: Apr. 1, 2009

Related U.S. Application Data
(60) Provisional application No. 61/088,280, filed on Aug. 12, 2008.

(51) Int. Cl. B05D 1/38

(52) U.S. Cl. 427/202

(57) ABSTRACT

The present invention is a kit and process designed for coating laminate kitchen countertops. The kit ingredients are combined and applied according to a predetermined timed sequence resulting in a refinished countertop having a realistic stone look. The kit coatings are all water-based, low VOC resins. All products and equipment items needed to complete a laminate kitchen countertop project are contained in the kit.

This application claims the benefit of prior filed U.S. Provisional Ser. No. 61/088,280, filed Aug. 12, 2008.

### BACKGROUND OF THE INVENTION

1. Field of the Invention

The invention relates generally to a laminate countertop coating kit and process in a do-it-yourself (DIY) format. Specifically, the invention relates to a method of re-covering a selected countertop to resemble an elegant stone composite surfaced countertop.

2. Background

The American kitchen has long ceased being a place where only the work of cooking is done. Rather, it seems, less and less cooking is done, and more gathering, chatting, even partying goes on in kitchens across the country. As a result, kitchen styling and trends have become more difficult to keep up with, more desirable and, naturally, progressively more expensive. What was once sturdy board and paint is now stone, stainless, and ceramic. A kitchen update has little to do with function and everything to do with appearance and styling cues.

However, it is not every family that can set aside the resources necessary to stay with trend and features of kitchen design. To pick but one familiar kitchen item to update: the countertop, creates an endless array of selection and cost. From tile, to formica, to stainless, to corrian, to butcher-block, to laminates, to all manner of stone and stone composites, the choices and cost gradations are endless. A switch from one to any other is destructive and costly.

It would be desirable to have a simple, step-by-step kit capable of coating widely installed laminate kitchen countertops with no demolition or sink removal. Realizing a typical laminate kitchen countertop removal and replacement is quite involved, there currently exists a need for homeowners to have a water-based, green, inexpensive, quickly installed DIY coating kit available which, when installed, achieves a realistic stone look for a fraction of the price of new kitchen countertops.

### SUMMARY OF THE INVENTION

The present invention advantageously fills the aforementioned deficiencies by providing a laminate countertop coating kit in a do-it-yourself format

The present invention is a DIY kit and process which contains all of the equipment and materials necessary to coat an average size laminate kitchen countertop. The kit includes a detailed installation DVD and written manual.

The kit of the present invention will include all of the equipment and materials needed to complete a laminate kitchen countertop project. The kit and process is intended to be used by persons having little or no experience in surface treatments. Merely following the sequence of steps using the kit contents is all that is required.

The kit offers virtually unlimited color selection combinations, along with environmentally friendly, VOC compliant, water-based, low odor green products that achieve a tough beautiful stone look finish that is heat resistant, stain defiant and impervious to any widely used household chemicals or cleaners. Furthermore, the present invention may be installed directly over existing kitchen laminate countertops, therefore saving demolition time, and saving money over installing new kitchen countertops.

The present invention process enables the creation of any color combination desired. The installation process is easy to use by virtue of the numerical sequencing system and time elements. The design and installation of the present process results in a semi-gloss orange peel finish, which over time, shows little if any wear and tear in ordinary kitchen use. The design of the coating system and elements described herein, are unequalled in ease of application, safety, durability and function.

Finally, it is an object of the present invention to provide a laminate countertop coating kit in a do-it-yourself format that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective view of all the components of the process kit 10.

FIG. 2 is a schematic flow diagram of the do-it-yourself application process of the invention 10.

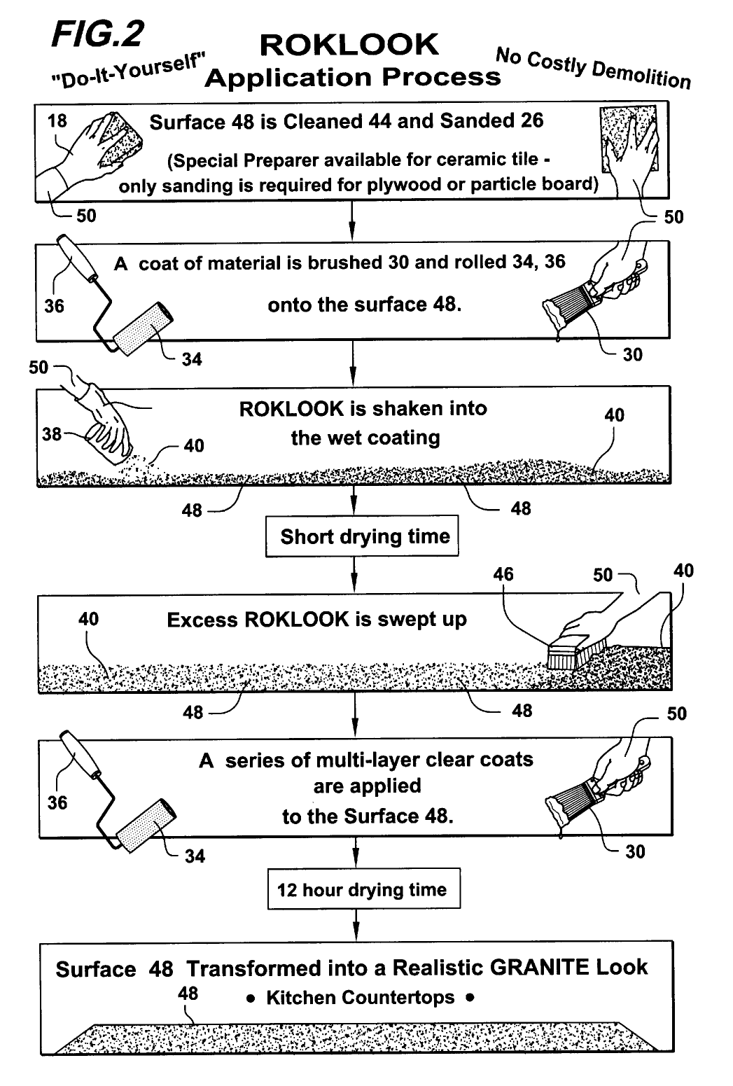

### DETAILED DESCRIPTION OF THE INVENTION

The present invention is directed to a laminate countertop coating kit in a do-it-yourself format.

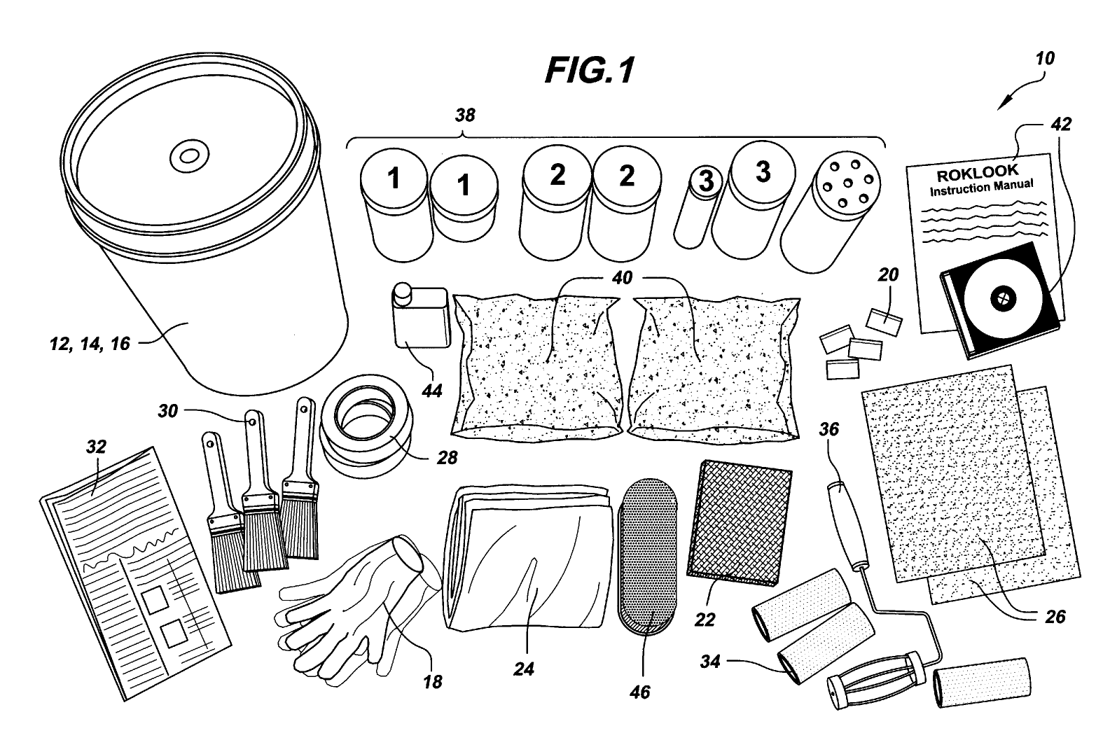

With reference to FIG. 1, the do-it-yourself kit for this coating process is made up of the following components: 1 four ounce bottle of biodegradable cleaning solution 44 (APF Orange Clean), 2 pairs of powder free latex gloves 18, 2 safety razor blades 20, 2 non-shedding scratch pads 22, 2 white terry towels 24, 2 sheets 80 grit wet-dry sandpaper 26, 1 roll of painter's grade 1½ inch masking tape 28, 1 chip sweeping brush 46, masking newspaper 32, 3 4″ non-shedding roller covers 34, 1 4″ roller handle 36, 3 2″ premium cut-in brushes 30, 1 quart labeled ##1 colored resin, 1 pint labeled ##1 clear resin, 2 quarts labeled ##2 resin, 1 quart labeled ##3 resin, 1 pint labeled ##3 resin, 1 plastic shaker can, 10 pounds of “rok look” colored chips ⅛ sized 40, 7 plastic containers appropriately labeled with contents 38, 2 plastic bags, 1 instructional DVD 42, 1 application user's guide.

The respective resin specifications for Nos. 1-3 are as follows: The #1 resin is a modified bisphenol A epoxy resin cross-linked with a water soluable amine adduct. The mixing ratio is 4 parts A to one part B. The solid content by weight is 51%. The application rate is 250 square feet per gallon. The VOC content is 50 grams per liter. The pot life of the #1 resin is 2-3 hours. The #1 resin is color matched to the specific chip blend that is sent out in each Roklook kit.

The #2 resin is a waterbased small particle, clear acrylic emulsion. This product is a single component resin. The solid content of this product is 35% by weight. The application rate for this product is 250 sq. feet per gallon. The VOC content is 75 grams per liter.

The #3 resin is a polyester and acrylic polyol crosslinked with an aliphatic polyisocynate. The mixing ratio of this resin is 4 parts A to 1 part B. The solid content of this resin by weight is 48% The application rate is 275 sq. feet per gallon. The VOC content is 50 grams per liter. The pot life is 3 hours at 77 degrees. This resin, like the #2 resin, is clear.

The selected resins should all be VOC compliant, water-based, low odor, user friendly coatings. The process may be applied selectively to portions of or entire countertop surfaces at the discretion of the user. In its most preferred form, all horizontal, vertical, and edge elements of an entire countertop area are treated in a single application of the process. The countertop re-finishing process in accord with the present invention comprises the following steps, in sequence:
Remove any objects from the kitchen countertop to be coated.
With the now empty 6 gallon bucket 16, put one gallon of water in the bucket, then pour the entire bottle of cleaning solution 44 into the water, and mix together.
Using scratch pad 22, scrub the kitchen countertop with the cleaning solution in the bucket. Have a safety razorblade 20 handy to remove any foreign objects from the surface such as tape, paint spatters, glue, etc.
Scrub the kitchen countertop completely, then empty used water out of the bucket, and fill the bucket with one gallon of clean water.
With the supplied terry towel 24 and clean water, rinse and wipe the entire kitchen countertop clean.
Empty and refill the bucket with 1 gallon of clean water and the damp terry towel.
Take the wet terry towel 24 from the bucket, and dampen the countertop to be sanded.
Using a folded piece of 80 grit wet/dry sandpaper 26, sand a two foot section of countertop at a time, then rinse/wipe that area with the terry towel 24. Repeat this sanding and rinsing method paying close attention to sanding all 90 degree edges as well.

After all sanding is done, wipe countertop with terry towel and water.
Empty the used water out of the bucket, rinse it clean, and dry it out completely.
Using a dry terry towel 24, wipe the entire countertop dry.
Using masking tape 28, mask off any areas on the countertop area not to be coated as well mask off the floor underneath the countertop area.
Place a bag of colored chips 40 into the dry 6 gallon bucket, and have your paint tray with the bucket ready.
Fill the plastic shaker can about ¾ full of colored chips, and have them at the workstation area ready to use.
Remove the tape from the top of all of the resin containers, and don a pair of the latex paint gloves.
Open the two containers marked ##1 on the lid, and pour the 1 pint container into the 1 quart container, reseal the lid snugly on the one quart container, and shake well for two minutes. Take one of the two inch brushes provided, and coat all of the vertical countertop areas first with the mixed ##1 resin. Because the resin dries fairly quickly on the surface, take care to only coat about 2 or 3 feet of the vertical sections at a time.
Take a liberal amount of chips from the bucket and lay them on the horizontal surface right below the vertical area being coated and throw them by hand into the coated vertical surface until fully covered.
Using a paint tray with chips in it for the edge application will work well. Liberally throw the chips into the wet coating, until you have full coverage of the resin with the chips.

Continue this process in sections until you have coated and chipped all the vertical areas of the countertop.
Sweep the remaining chips on the horizontal areas back into the bucket with the chip sweeping brush 46.
With the brush and roller, coat the horizontal areas of the countertop with the mixed No. 1 resin.
Using the plastic shaker can (selected from group 38) proceed to shake colored chips into the wet horizontally disposed resin, refilling the shaker can with chips from the 6 gallon bucket as needed taking care not to empty the entire shaker can contents. You will use the paint tray with chips in it for the edges. Just throw them in by hand.
Once the horizontal areas are completely chipped, allow surface of the countertop to dry for a minimum of 1 hour. Check surface after 1 hour by putting your bare hand on top of the chip surface. If it feels tacky, let the surface dry for an additional ½ hour.
Once dry, use the sweeping brush 46 and the paint tray to sweep and collect chips from all of the vertical and horizontal areas.
Using a folded piece of the 80 grit sandpaper, sand entire countertop area. Take care not to sand too aggressively. Just a light to medium pressure on the sand paper will do fine.
Using the chip sweeping brush, sweep entire surface well and discard residue.
Inspect the entire project, especially the edges, for any missed spots.
Using a newly installed 4 inch roller cover 34 on the roller handle 36. Take 1 quart of the ##2 resin and shake it for 2 minutes. Bring the roller 34 and a clean 2 inch brush 30 and the shaken ##2 container over to the countertop. Open the ##2 container and pour out small amounts of the resin onto the horizontal surface. Apply the resin with the roller and brush on the surface until it is completely coated.
Using the shaker can of chips, shake a layer of chips over the entire treated horizontal area, achieving full coverage, refilling the shaker can as needed.
Again, using the brush and ##2 resin container over, apply a coating of the ##2 resin onto all the vertical areas. Then, using the paint tray with chips, proceed to hand throw the chips from the paint tray into and against all the vertical areas until they are fully covered.
Allow the entire countertop area to dry for 1 hour.
Using the sweeping brush and the paint tray, sweep chips from all vertical and horizontal areas back into the paint tray.
Using a folded piece of 80 grit sandpaper, sand entire countertop using medium sanding pressure.
Sweep the sanded material from the countertop and discard.
Using the same brush and roller used for the ##2 resin application, apply another coat of the ##2 resin onto the entire surface of the countertop. Using your paint tray with some chips in it, throw chips onto any missed spots, paying close attention to all edges of the project.
Allow countertop area to dry for 1½ hours.
Using the chip sweeping brush, brush off chips from any areas that were touched up onto the floor, and sand those touched up areas with the 80 grit sandpaper and sweep residue into a kitchen trash can or onto the newspaper on the floor.
Again, using a folded piece of 80 grit sandpaper, sand the entire countertop area using only light sanding pressure. Sweep and discard sanding residue.
Install a fresh 4 inch roller cover onto the roller handle, and have a fresh 2 inch brush ready. Open the two containers marked ##3, and pour the pint container contents into the quart container. Reseal the lid snuggly on the quart container and shake well for 2 minutes.
Starting with the vertical areas, apply a medium thick coat of the ##3 resin. This coating will eventually become the final finish coat.
Every 5 minutes, reseal the container of the ##3 resin and re-shake the contents for 30 seconds.
After all vertical areas are coated with the ##3 resin, coat the horizontal countertop areas. Apply a nice smooth even coat over the horizontal surface. Do not apply excessive pressure on the roller, let the roller do the work.
Allow countertops to dry for 1 hour. Remove all masking tape and paper from the floor and clean-up kitchen area. Allow the countertops to dry 12-15 hours before putting back into use.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims It is indeed intended that the scope of the invention should be determined by proper interpretation and construction of the appended claims and their legal equivalents, as understood by those of skill in the art relying upon the disclosure in this specification and the attached drawings.

1. A countertop area coating method, comprising the steps of:
cleaning said entire countertop area selected for coating using a water soluble biodegradable cleaning solution;
re-cleaning said entire countertop area using fresh water, a scratch-pad and scraping implements to remove all foreign residue from said countertop area;
wiping said countertop area using fresh water and a drying towel;
dampening said countertop area and thereafter sanding said countertop area a 1^{st} time using a medium grit wet/dry sand paper and cleaning and wiping away sanding residue;
optionally masking off any areas on said countertop area not to be coated using masking tape;
coating all of said countertop area with a well mixed No. 1 resin to create a wet coating;
liberally applying colored stone chips into said wet coating, until desired coverage of stone chips is achieved;
allowing said wet coating to dry until no longer tacky to touch;
sweeping said countertop area to remove unadhered stone chips;
sanding said countertop area a 2^{nd} time using a light to medium pressure;
sweeping said countertop area and discarding residue;
pouring out small amounts of a well mixed No. 2 resin onto said countertop area and further spreading said No. 2 resin evenly thereon;
distributing a second layer of stone chips over said countertop area;
allowing said said countertop area to dry for 1 hour.
sweeping unadhered stone chips from said countertop area;
sanding said countertop area a 3^{rd} time using a medium grit sand paper using medium pressure
sweeping said countertop area and discarding residue;
applying a second coating of said No. 2 resin onto said countertop;
allowing said countertop area to dry for 1½ hours
sweeping said countertop area of loose stone chips;
sanding said countertop area a 4^{th} time using a medium grit sand paper with light pressure;
sweeping and discarding sanding residue;
applying a medium thick coating of a well mixed No. 3 resin, shake mixing said No. 3 resin periodically during said application step;
allowing said medium thick No. 3 coating to dry for 1 hour.

2. A method as in claim 1, wherein:
vertical portions of said countertop are treated prior to treatment of adjacent and proximate horizontal portions, and wherein said respective applying steps of said stone chips to said vertical portions is accomplished by tossing said chips against a coated vertical surface of said countertop.

3. A method as in claim 1, wherein:
said No. 1 resin is comprised of a modified bisphenol A epoxy resin cross-linked with a water soluable amine adduct, having a mixing ratio is 4 parts A to one part B and wherein the solids content by weight is approximately 51%.

4. A method as in claim 1, wherein:
said No. 2 resin is comprised of a waterbased small particle, clear acrylic emulsion and is a single component resin with a solids content of approximately 35% by weight.

5. A method as in claim 1, wherein:
said No. 3 is a polyester and acrylic polyol crosslinked with an aliphatic polyisocynate having a mixing ratio of 4 parts A to 1 part B and wherein the solids content is approximately 48% by weight.
